(19) United States
(12) Patent Application Publication
(10) Pub. No.: US 2007/0075023 A1
(43) Pub. Date: Apr. 5, 2007

(54) Apparatus and method for a splint

(76) Inventor: Donald Wallace, Hanna City, IL (US)

Correspondence Address: HUSCH & EPPENBERGER, LLC, 190 CARONDELET PLAZA, SUITE 600, ST. LOUIS, MO, 63105-3441, US

(21) Appl. No.: 11/228,130

(22) Filed: Sep. 16, 2005

Related U.S. Application Data
(63) Continuation-in-part of application No. 11/201,040, filed on Aug. 10, 2005.

(51) Int. Cl. B01J 49/00

(52) U.S. Cl. 210/672

(57) ABSTRACT

A medical splint and/or procedure fluid control apparatus includes a procedure bed, and at least one wing. The wing is along at least one longitudinal edge of the procedure bed, and is moveable to a plane non-parallel with a plane of the procedure bed. The apparatus has at least one absorbent portion being on a surface of the procedure bed or the wing. The at least one absorbent portion is disposed to face the patient. At least one adhesive portion of the fluid control apparatus is also on a surface of the procedure bed or said wing disposed to face patient. The splint and/or procedure apparatus may be made of molded pulp.

### CROSS-REFERENCE TO RELATED APPLICATIONS

This application is a continuation-in-part of U.S. patent application Ser. No. 11/201,040 filed on Aug. 10, 2005.

### BACKGROUND OF THE INVENTION

1. Field of the Invention

This invention is in the medical supply field, in particular in the field of devices for phlebotomy procedures, intravenous catheter insertions and extremity wound treatment.

2. Related Art

Speed, accuracy and cleanliness are always valued in medical treatment. This is particularly true in medical procedures involving the management of blood, including intravenous catheter placement and trauma treatment. The advent of HIV, hepatitis C and other blood borne pathogens increases the importance of the need for accurate, controlled, efficient and economical tools for executing these medical procedures.

In particular when a trauma patient enters an emergency room with an extremity wound, or more commonly when a nurse or other health care provider places an intravenous catheter, or when blood samples are drawn, there is a need for containing, controlling and absorbing any spillage of blood during the procedure. Furthermore, there is a need to provide economic, easy to use equipment that is preferably disposable and may also may preferably have multiple uses.

Currently, emergency rooms and phlebotomists have little more than towels or gauze pads or bandages for absorbing any blood spilled during a blood sampling, IV catheter placement or treatment of some trauma to extremities. There is a need in the art for a blood control device tailored to these circumstances.

Splint Material

Ideally splints for supporting injured body parts would be custom fitted to that patient's anatomy. However, in many situations, most especially an emergency medicine and in the field, it is impractical to attempt custom fitting procedures. Currently there are available metal lattices; a combination of metal strips that can be bent to a desired shape. However, they are cumbersome, heavy and require an ace bandage or other type of wrap to hold them in position. There are also available inflatable splints. These may be full cylinders, in which case they need to be slipped onto the appendage that is injured, which is often impractical, or they are flat wraps which may not properly fit. Inflatable splints are also unpopular because they obscure from view the injury and require the splint to be removed for treatment. Accordingly, there is a need in the art for a splint material that can be custom fit, molded or otherwise adapted to the particular patient and/or injury at hand, particularly by paramedics at an accident site. Moldable splints may also help address the possibility of deformities created by the injury. It is advantageous to have a moldable or otherwise adjustable splint that can be custom fit in pediatric injuries.

As listed above, inflatable devices and metal devices and other type of moldable devices are not absorbent. There is a need in the art for splint material that is both moldable and absorbent. Splint material should also be lightweight. Prior moldable splints are typically heavy, as for example in the cumbersome metal lattice.

Cost has become a prominent issue in modern healthcare. To the extent it is possible to maintain required standards for good care, it is advantageous to use economical equipment, and in particular inexpensive splint material.

There is a further need in the art for additional shock absorbing capabilities in splints in order to protect the injured appendage, particularly in those situations or in the field where patient transport may require moving the patient on a stretcher, gurney or ambulance across uneven or bumpy ground.

There is a further need in the art for inexpensive disposable splints that may be used in athletics or other occasional use after a permanent cast has been removed but before full healing of an appendage, for example a broken limb, has been achieved.

Finally, while not unique to the medical field, there is a growing demand in the marketplace for material and equipment that can be made of recycled materials.

### SUMMARY OF THE INVENTION

The invention herein is an absorbent procedure bed for use upon extremities. The bed may be flexible or semi-rigid. An absorbent layer is designed to face the patient and come into contact with the extremity upon which the procedure is to be performed. For further advantageous control, adhesive is provided at selected locations on an upper surface of the absorbent sheet such that the adhesive may be disposed to adhere to the patient's skin at selected locations. Adhesive areas may be interspersed with absorbent areas.

In another aspect of the present invention, the procedure bed is provided with additional tools useful to the phlebotomist or other medical practitioner. These may include a pocket or series of pockets or bandoleers for placement of blood sample vials or other tools. It may further include additional strips having attachments that may be adhesive, hook and eye attachments or otherwise for holding the procedure bed to the extremity and/or for holding an intravenous catheter in a desirable, practitioner selected position. It may further include a strip or sleeve at a proximally disposed edge of the procedure bed into which a tourniquet may be placed. Finally, a sleeve, slot or other receptacle may be disposed on a bottom portion of the procedure bed for insertion of stiffeners such as battens or boards. Such stiffeners would advantageously keep an extremity rigid for trauma procedures involving bone fractures or otherwise requiring a splint.

The procedure bed may be entirely flexible or, in the alternative, may be semi-rigid and formable such that wings of the procedure bed may be elevated on either side of the extremity for further control of bleeding, or spillage.

The absorbent sheet and procedure bed of the present invention may further advantageously be constructed and arranged to be maintained in a sterile individual packaging, or sterile multiple unit packaging, such as in a roll, or nonsterile multiple packaging as in stacks or in rolls.

Another aspect of the present invention is a provision for control of fingers and hands in a pediatric application. A slot, sleeve, adhesive band or adhesive bed may be disposed at a distal end of the procedure bed in order that a small child's fingers, hands or foot may be more readily held stable during a procedure.

Splint Material

The present invention includes fabrication of splints or procedure beds from molded pulp. Such splints may be cut to an appropriate length, notched for the shaping of curves or otherwise custom shaped to the anatomy required. Applications include pediatric applications, injuries causing a deformity in the anatomy, patients with the extremes of height or weight and/or other variabilities in the presentation of injured patients. The present invention may present an absorbent surface to the wound which absorbent surface is integrally fabricated into the splint made of molded pulp. The molded pulp splint of the present invention may include preconfigured creases or thin lines for cutting, or, optionally, perforations. The molded pulp splint of the present invention may include a pressurized, smooth, glossy, waterproof or an otherwise finished outer surface. The molded pulp splint of the present invention may include bulbs, blisters, ridges, or other integrally fabricated appendages or shapes dimensioned and oriented for shock absorption.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of the procedure that of the present invention.

FIG. 2 is a cutaway side view of the procedure in use.

FIG. 3 is a top view of showing adhesive and absorbent areas.

FIG. 4 is a perspective view showing adhesive and absorbent areas.

FIG. 5 is an end view showing sleeves for stiffening battens.

FIG. 6 is a top view of an alternative embodiment.

FIG. 7 is a side view of an alternative embodiment.

FIG. 8 is a perspective view of an alternative embodiment including a temporary splint.

FIG. 9 is a side view of a molded pulp leg splint according to the present invention.

FIG. 10 is a side view of a molded pulp finger splint.

FIG. 11 is a top view of a hand showing a molded pulp finger and a thumb splint.

FIG. 12 is a side view of a molded pulp arm splint.

FIG. 13 is a side view of a molded pulp cervical splint.

FIG. 14 is a top view of a molded pulp cervical splint.

FIG. 15 is a front view of a molded pulp cervical splint.

FIG. 16 is a top view of a molded pulp short arm cast.

### DETAILED DESCRIPTION OF THE PREFERRED EMBODIMENTS

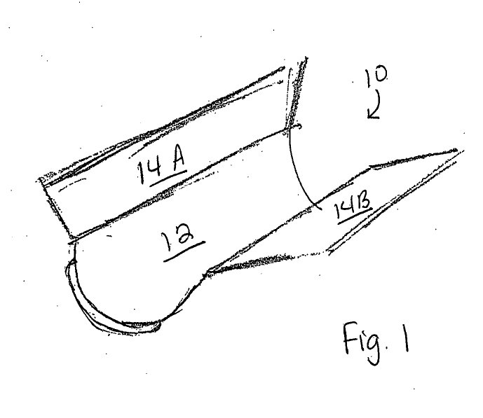

The following description of the preferred embodiment(s) is merely exemplary in nature and is in no way intended to limit the invention, its application, or uses. Referring now to the drawings where like numbers indicate like elements, FIG. 1 is a perspective view of the procedure bed of the present invention. Procedure bed assembly 10 is comprised of a procedure bed 12 flanked by wings 14A and 14B oriented parallel with the longitudinal axis of the procedure bed 12 and on the sides of the procedure bed. The procedure bed 12, wings 14 individually, together or in any combination may be either fully flexible or semi-rigid. A curvature may be obtained by constructing the procedure bed assembly with flexible plastic panels, or by constructing the procedure bed assembly with sleeves or rear adhesive portions for placement of stiffeners. In the embodiment depicted in FIG. 1, a sleeve 16 is provided underneath the procedure bed 12 for insertion of a longitudinal stabilizer 18.

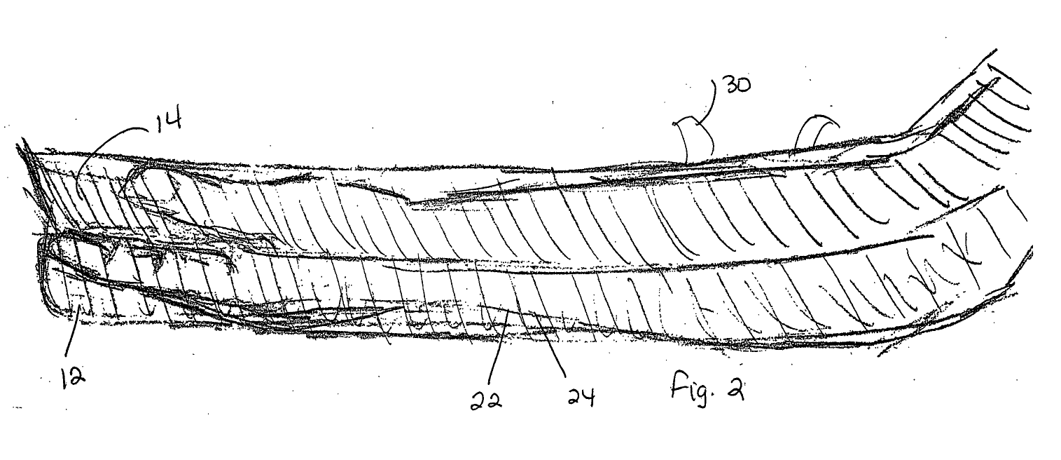

FIG. 2 shows the procedure bed assembly 10 in use. A patient's arm is depicted in the side view. Procedure bed 12 is placed on a procedure table (not shown) and the patient's arm is placed on the procedure bed 12. In those embodiments having stiffening components, the patient's extremity is placed in the trough formed by the procedure bed 12. Wings 14 are disposed to angle upwards and away from an upper aspect of the patient's extremity upon which a procedure is to be formed. In this manner, a bleeding extremity, an extremity that needs to be washed or an otherwise clean extremity that may be subject to spillage or bleeding during a procedure is effectively surrounded on the bottom and sides in order that blood, lavage or other fluids are controlled and retained in the area of the procedure bed there to be absorbed.

Both the procedure bed 12 and wings 14 in the embodiment depicted in FIG. 2 are shown having alternate transverse strips. These strips represent a disposition of adhesive 22 and absorbent material 24, which may be alternating in the embodiment depicted in FIG. 2. Construction of the procedure bed assembly may be by starting with an absorbent substrate such as gauze, absorbent polymers or other absorbent materials with adhesive strips attached on top of the absorbent substrate in order that an adhesive surface face the patient's extremity. In this manner, the procedure bed assembly is held in its desired, advantageous position while an absorbent surface is maintained proximal to the patient's skin and, in some cases to a bleeding wound. Additionally, straps or tabs 30 may be placed on the wings as depicted. These straps or wings may be constructed with more adhesive material, hooks and eyes, hook and eye pads or other means for attachment of tabs. These tabs may be used to further stabilize and maintain the procedure bed in the desired position. These strips may further be used to stabilize and maintain an intravenous catheter line in a desired position. In most cases this position of an IV line is parallel with the longitudinal axis of the extremity and immediately adjacent to skin. In the prior this position was maintained only with simple adhesive tape or not at all.

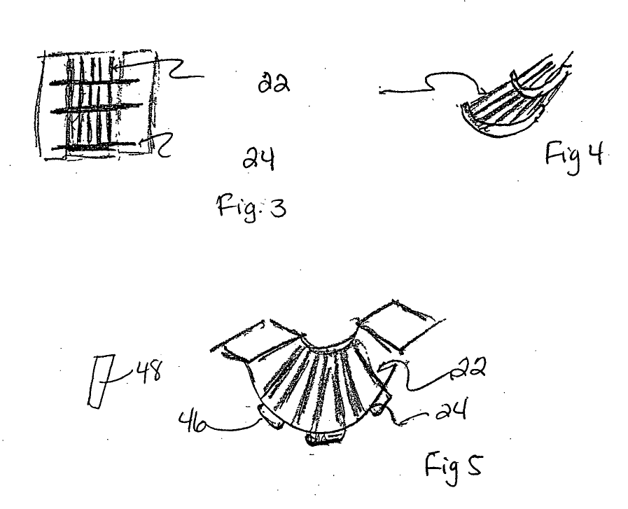

FIGS. 3 and 4 depict a top view and a perspective view, respectively, of an alternative design configuration for adhesive and absorbent portions of an upper surface of the procedure bed assembly. Adhesive strips 22 may be arranged perpendicular to absorbent areas 24. It is within the scope of the present invention that any geometric pattern may be used to provided that there is an absorbent portion and adhesive portion of an upper surface of the procedure bed facing the patient's extremity. Moreover, adhesive areas are provided with a non-adhesive cover which is removed immediately before use exposing the adhesive surface to the patient's skin. The procedure bed assembly may be constructed and arranged so that different adhesive portions are provided with separate covers. In this fashion, a healthcare practitioner may selectively expose the adhesive on different adhesive areas in order to tailor the use of the procedure bed assembly to the patient need at hand. For example, the cover may be left on an adhesive strip to be placed immediately proximate a wound so that the device does not stick to the wound.

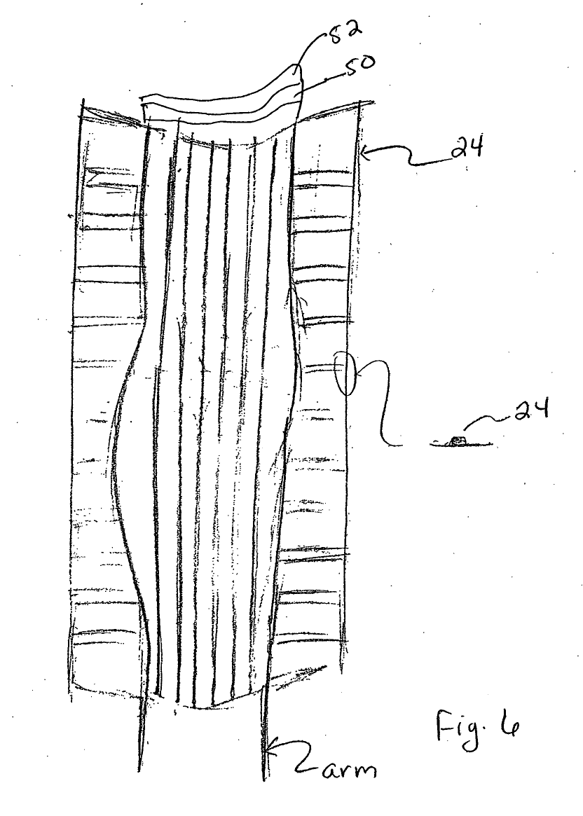

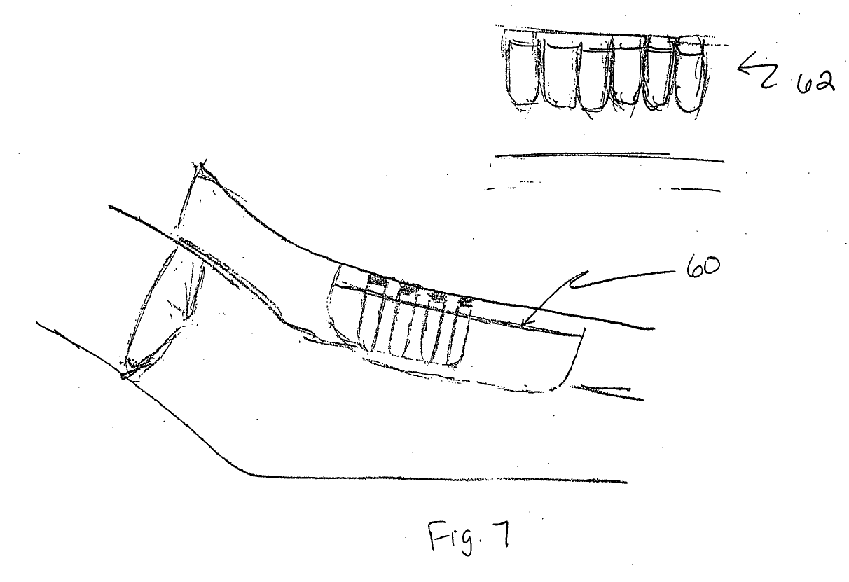

FIG. 5 shows an alternate embodiment having multiple sleeves 46 for receiving and maintaining stabilizing battens 48. FIG. 5 also shows longitudinal alternating adhesive and absorbent areas, again with separate covers being provided for the adhesive areas. FIG. 6 is a top view of another alternative embodiment of the present invention. The patient's arm is shown over the procedure bed. Shown in phantom on the underside of the patient's arm are the longitudinal alternating adhesive and absorbent strips on the procedure bed portion 12. The wings are disposed with alternating with a series of absorbent ribs oriented in a transverse direction. Such transverse absorbent areas may be useful in a situation where the extremity is not parallel to the ground. As such circumstances, blood, water or lavage fluid would flow downwards. The raised ribs of the depicted embodiment would aid in controlling spillage of such fluid.

Also depicted in FIG. 6 is a cuff 50 having either a permanent transverse through hole for receiving a tourniquet, or, alternatively, a flexible wraparound portion with a transverse adhesive or other attachment strip 52. Thus, a user may place a tourniquet device, such as a rubber hose or latex strap (not shown) over the cuff portion thereafter to be wrapped around by the cuff and held secure in the user selected position by the adhesive portion 52.

FIG. 7 depicts a further alternative embodiment. Frequently phlebotomists and the like are charged with taking blood samples. This procedure is executed by piercing a vein, positioning a catheter in the vein and placing a socket device over the catheter. The socket device receives serial blood vials for taking multiple samples separately. The vials are placed one by one in the socket. Typically the phlebotomist places the empty bottles in any fashion on a procedure surface next to a patient's extremity before and after they are filled. A more satisfactory control of these vials is achieved by providing a temporary storage space for them on the procedure bed assembly. Hence, pockets 60 along the wings or bandoliers 62 are provided for this use.

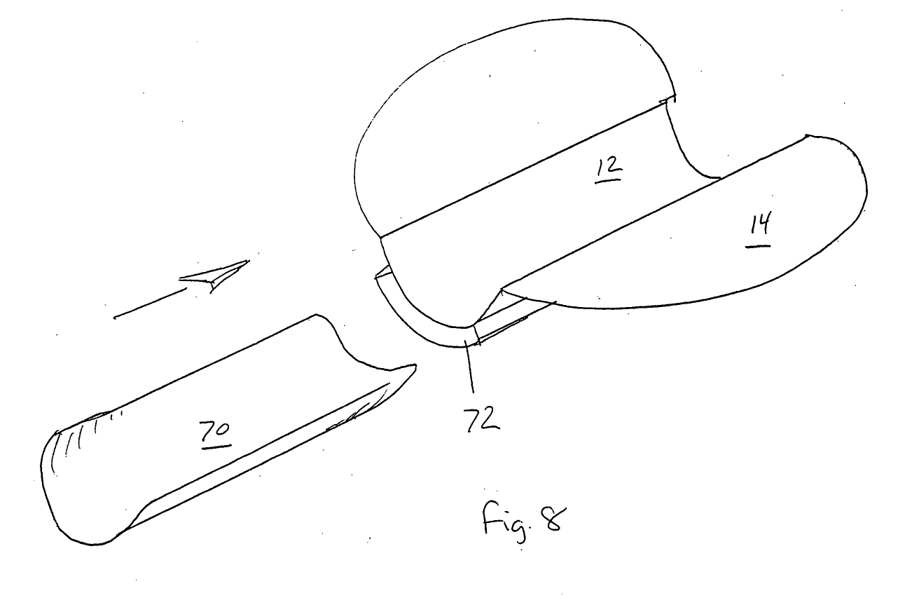

In another aspect of the present invention, the stiffeners may be rigid enough to provide a splinting effect for any fractures of the extremity being treated. In on-site emergency treatment and/or transportation, it is often beneficial to provide stability to an extremity wound that includes a fracture. Upon more thorough treatment, as for example at the emergency room of a hospital, complex wound treatment priorities may favor treating a badly bleeding vessel or a compromised nerve before reducing a fracture. While such prioritized treatment is proceeding, it is useful to maintain the extremity in a rigidly maintained position, as with a temporary splint. Accordingly, in FIG. 8, an embodiment of the invention is depicted wherein the procedure bed external surface includes a single large sleeve 72 dimensioned to receive a stiffening device 70 that is wider than the battens depicted in FIG. 5. With either the battens of FIG. 5 or the stiffener of FIG. 8, these devices may be rigid enough to provide a splinting effect for fractured extremities. In each case, the batten or stiffener may have some curvature around a radius substantially parallel with the long axis of the extremity being treated, and/or may be made of any appropriate material, including without limitation plastic or metal.

Molded Pulp Splints

Advantageously any of the splints or procedure beds the present invention may be made from molded pulp. Molded pulp is typically fabricated from recycled paper or cardboard products, for example newspaper. Molded pulp is material familiar to consumers as traditional egg crates, fruit packaging and light bulb packaging. Molded pulp is available in several configurations of hardness, density, weight and surface finish. All molded pulp materials are within the scope of the present invention. Advantageously, thick walled molded pulp, for example that having a thickness of 3/16 of an inch to ½ of an inch may be used. In alternate applications, thermoformed fiber may be used. These materials are shaped using various degrees of fluid content, pressure, stamping, heat and, in some cases thereafter surface finishing.

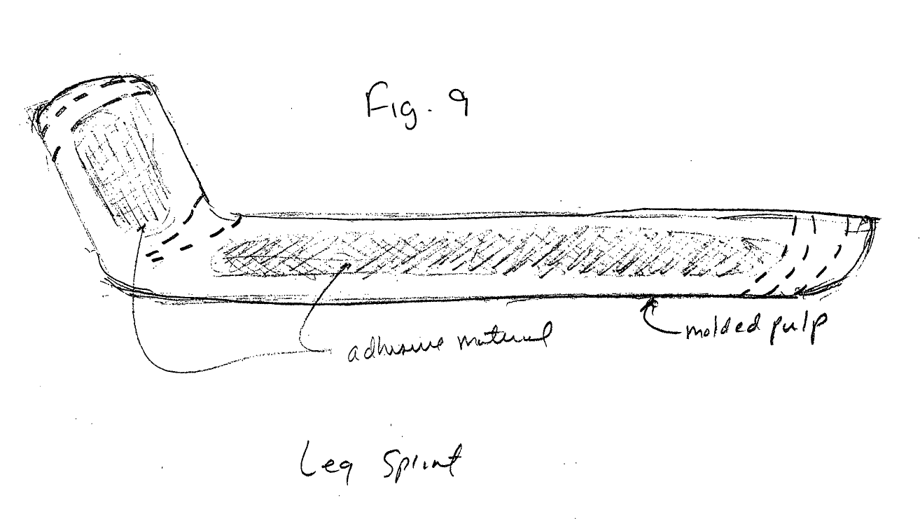

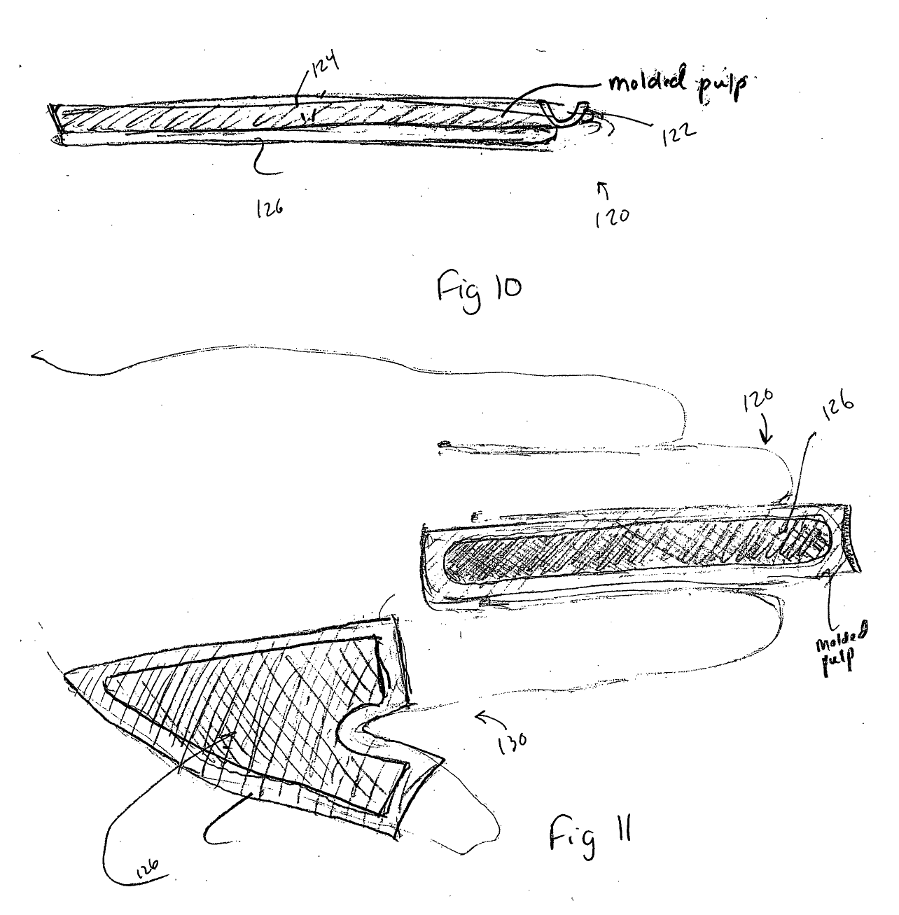

FIG. 9 depicts a leg splint 100 made of molded pulp. The splint has a concave portion 102 into which the limb is placed. The splint has a long primary portion 104 for the leg and a shorter portion 106 for the foot. In the depicted embodiment, adhesive sections 108 are added onto the splint surface in order to promote temporary fixation of the splint to the limb.

Because the splint is made of molded pulp, while it has sufficient resiliency to retain the limb having a set bone or otherwise stabilized fracture, the molded pulp material may be cut and bent to shape in order to more exactly custom fit the anatomy of the patient and injury at hand. Scissors are typical paramedic equipment and accordingly may be used as for example at the proximal end 112 or distal end 114 of the splint in order to adjust its length. These adjustments may be promoted by the presence of preconfigured creases or other thin areas of the splint wall as at 116. Optionally, these lines may be perforated to further ease cutting or tearing them to shape. Of course, because the material is made of molded pulp, the healthcare provider is free to cut through any portion including the center of the splint.

The splint may be further be molded by cutting notches at portions of the splint corresponding to joints in the anatomy or as may be otherwise required. Creases or perforations to aid in this adjustment may also be prefabricated into the molded pulp splint, as for example at a joint 118.

Molded pulp may be easily fabricated with varying surface textures. In the depicted embodiment, an inner surface, preferably the concave surface 102, is textured with a less smooth finish in order to promote absorbency in the event of a compound fracture or other bleeding wound.

Smaller hand splints 120, 130 are shown made of molded pulp. Once again a concavity 122 is shown in FIG. 10 for receiving a finger. Notches 124 again may be cut in order to provide for a bend in the figure as the healthcare provider sees fit. A thumb splint 130 may be preconfigured either a flat or semi-concave shape and thereafter cut, notched or bent along creases or perforations to more precisely accommodate the anatomy of the injured patient. Adhesive portions 126, 136 may be included.

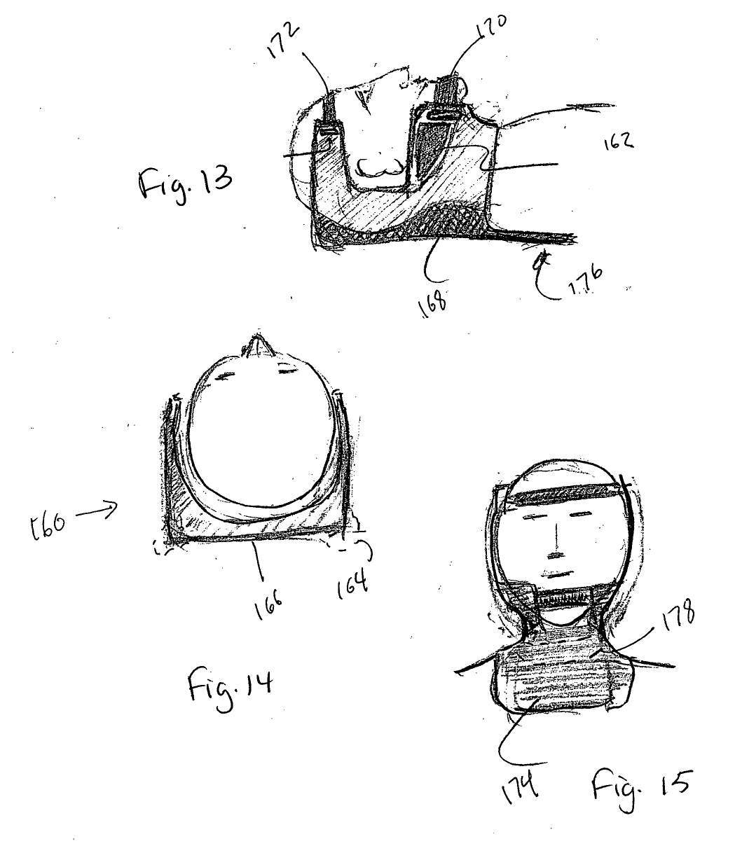

FIG. 12 depicts a arm splint 140. Such a splint may be custom fit by cutting or tearing along notches 142, 146 in order to create a shorter cast or retain a longer cast. The notches 142 may be used to increase the angle of the cast. As in the previous embodiments, an adhesive material 144 may be included.

Also depicted in FIG. 12 are shock absorption blisters, ridges or other configurations 148. In the depicted embodiment, these may be integrally fabricated into the molded pulp splint.

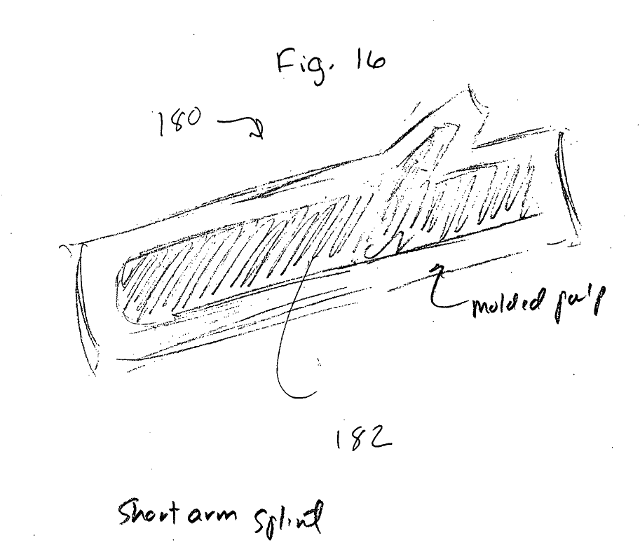

FIGS. 13, 14 and 15 are side, top and front views, respectively, of the cervical collar made of molded pulp 160. Visible in FIG. 13, an adhesive portion 162 may be placed on the outside surface of the cervical collar for fixation of chin strap 170 or forehead strap 172. This adhesive material may be a tacky material, releasable glue or a hook and eye material such as Velcro®. FIG. 14 further shows advantageous placement of shock absorbing ridges, extensions 164 or the like, particularly at the corners of a cervical collar that is externally block shaped. Thus a flat back surface 166 may aid in stabilizing the patient's head, as on the stretcher or gurney. Shock absorption ridges 164 may run along the flat portion 166, or be fabricated into the edges.

Also visible in FIG. 13 is the advantageous placement of foam 168 or other moldable material for further support of the injured patient. Optionally, the molded pulp itself may be fabricated with a preconfigured convexity below the patient's neck and/or at the sides of the neck in order to more precisely fit the given patient.

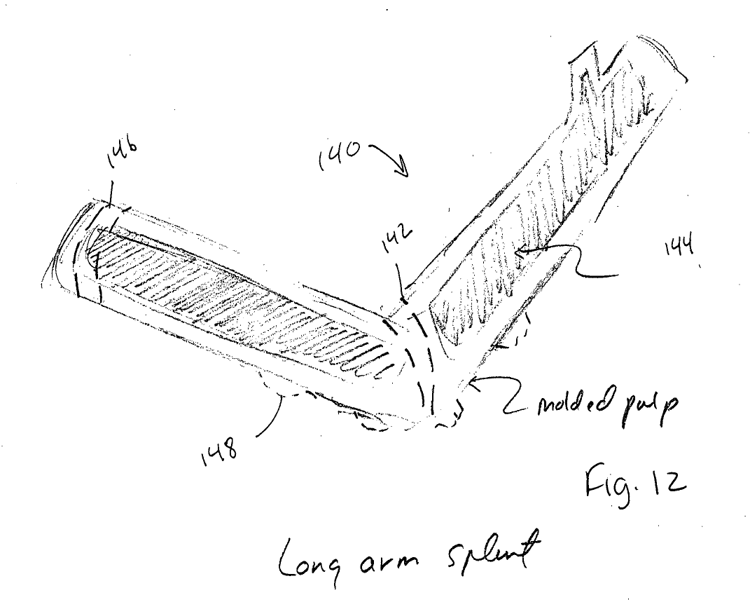

FIG. 15, a front view, depicts a front thoracic extension 174. FIG. 13, the side view depicts a dorsal thoracic extension 176. The juncture between these thoracic extensions and the true cervical portion of the molded pulp collar provide an ideal location for creases or perforations 178 allowing the device to be bent, notched, or cut as necessary to closely fit the patient and create a custom fit.

The features in the molded pulp splints may be combined with the battens, stiffeners and the sleeves to accommodate them depicted in FIGS. 1-8 in order to further provide for custom fitting in a fast, economic and readily accessible manner.

FIG. 16 depicts a short arm cast 180 having a thumb splint. As before, an adhesive material 182 is depicted.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A medical procedure fluid control apparatus comprising:
a procedure bed;
at least one wing, said at least one wing being along at least one longitudinal edge of said procedure bed, said at least one wing being moveable to a plane non-parallel with a plane of said procedure bed;
at least one absorbent portion of said fluid control apparatus, said at least one absorbent portion being on a surface of said procedure bed or said wing disposed to face a patient;
at least one adhesive portion of said fluid control apparatus, said at least one adhesive portion being on a surface of said procedure bed or said wing disposed to face a patient; and
wherein at least one of said procedure bed, said at least one wing or said absorbent portion is made from molded pulp.

2. The method of making a medical procedure fluid control apparatus comprising:
fabricating a procedure bed;
attaching at least one wing along at least one longitudinal edge of said procedure bed, said at least one wing being moveable to a plane non-parallel with a plane of said procedure bed;
facing towards a patient at least one absorbent portion, said at least one absorbent portion being on at least one of said procedure bed or said wing;
facing at least one adhesive portion of said fluid control apparatus towards a patient, said at least one adhesive portion being on one of said procedure bed or said wing; and
wherein at least one of said procedure bed, said step of fabricating said procedure bed, said attachment step of said absorbent portion or said facing step is made of molded pulp.

3. A splint comprising:
a concave portion dimensioned to receive a portion of an injured patient's anatomy;
an adhesive portion attached to said splint;
an absorbent portion, said absorbent portion being oriented towards the patient; and
said splint being fabricated from molded pulp.

4. The splint of claim 3 further comprising shock absorption extensions.

5. The splint of claim 3 wherein said shock absorption extensions are integrally fabricated in the splint of molded pulp.

6. The splint of claim 3 further comprising creases.

7. The splint of claim 3 further comprising perforated lines.

8. The splint of claim 3 wherein said adhesive portion is oriented to contact the patient.

9. The splint of claim 3 wherein said creases are configured in a notch shape.

10. The splint of claim 3 further comprising a sleeve, said sleeve being dimensioned to receive a stiffener.

11. The splint of claim 3 wherein said absorbent portion is fabricated by texturing said molded pulp.

12. The splint of claim 3 wherein said adhesive portion and said absorbent portion are alternating.

13. The splint of claim 3 further comprising at least one wing.

14. The splint of claim 3 further including a transverse throughhole on a proximal end of said splint, said throughole being dimensioned to receive and retain a tourniquet.

15. The splint of claim 3 further comprising at least one pocket, said packet being attached to said splint and said pocket being dimensioned to receive and retain a vial.

16. The splint of claim 3 further comprising at least one adhesive tab for retaining said splint in a selected position around a patient.
